(19) United States
(12) Patent Application Publication
(10) Pub. No.: US 2018/0111160 A1
(43) Pub. Date: Apr. 26, 2018

(54) METHOD FOR COATING THE INNER WALL OF A TUBE

(71) Applicant: SAINT-GOBAIN PERFORMANCE PLASTICS FRANCE, Charny Oree de Puisaye (FR)

(72) Inventors: Pascaline HAYOUN, Philadelphia, PA (US); Alban LETAILLEUR, Paris (FR); Jeremie TEISSEIRE, Antony (FR); Etienne BARTHEL, Bourg-la-Reine (FR); Francois LEQUEUX, Paris (FR); Emilie VERNEUIL, Paris (FR)

(21) Appl. No.: 15/793,503

(22) Filed: Oct. 25, 2017

(30) Foreign Application Priority Data
Oct. 25, 2016 (FR) 1660347
Oct. 25, 2016 (FR) 1660348
Dec. 20, 2016 (FR) 1662846

(51) Int. Cl. B05D 5/08; C09D 5/16; B05D 7/00; B05D 7/02; B05D 7/22; C08K 5/5419; C08K 3/36

(52) U.S. Cl. CPC B05D 5/08; C09D 5/1681; B05D 7/50; C08K 2201/005; B05D 7/22; C08K 5/5419; C08K 3/36; B05D 7/02

(57) ABSTRACT

The invention relates to a method for forming a coating in the inner wall of a tube, including the following operations:
moving a segment of a liquid composition of coating particles in suspension inside the tube at a constant controlled speed at least equal to 2 cm/s, so as to drive a homogeneous liquid film over the inner wall of the tube, and
allowing the solvent of the liquid composition to evaporate and the coating particles in suspension to be deposited on the inner wall of the tube.

### CROSS-REFERENCE TO RELATED APPLICATION(S)

This application claims priority under 35 U.S.C. § 119(a) to, and incorporates herein by reference in its entirety for all purposes, French application FR1660347, filed Oct. 25, 2016, entitled “PROCESS FOR COATING THE INNER WALL OF A TUBE,” to Pascaline HAYOUN et al. and which is assigned to the current assignee hereof. This application also claims priority under 35 U.S.C. § 119(a) to, and incorporates herein by reference in its entirety for all purposes, French application FR1660348, filed Oct. 25, 2016, entitled “METHOD FOR COATING THE INNER WALL OF A TUBE,” to Pascaline HAYOUN et al. and which is assigned to the current assignee hereof. This application also claims priority under 35 U.S.C. § 119(a) to, and incorporates herein by reference in its entirety for all purposes, French application FR1662846, filed Dec. 20, 2016, entitled “CYLINDRICAL TUBE WHOSE INNER WALL IS CONSTITUTED BY A HYDROPHOBIC COATING,” to Pascaline HAYOUN et al. and which is assigned to the current assignee hereof.

### FIELD OF THE DISCLOSURE

This disclosure, generally, is related to a method of coating the inner wall of a tube.

### BACKGROUND

Many industries circulate liquids in tubes, for example, tubes made from a polymer material, or even from glass or metal, whether in dispensing water, or in food applications (coffee, soup, etc., dispenser) or medical applications (perfusion, etc.).

This circulation of liquids generally causes changes in the surface state of the inner wall of the tube: droplets are likely to remain adhered to the wall after the passage of a large quantity of liquid in the tube, then, after evaporation, to leave a slight solid deposit creating a surface irregularity likely to retain other droplets during a subsequent passage of liquid in the tube.

It is therefore interesting to be able to coat the inner wall of a tube with various functional layers resulting in decreasing or eliminating the attachment of droplets when a quantity of liquid passes: this may involve a layer modifying the surface tension of the inner wall, hydrophilic or hydrophobic, for example. It may involve any other functional layer, for example colored in the case of a transparent tube, etc. These functional layers must have good adhesion with the inner wall of the tube and must be durable, i.e., retain their initial quality over the course of the passage of the largest possible quantities of liquid.

These layers must be as regular as possible in terms of thickness, composition, morphology and appearance over their entire deposition surface. Their formation method should be compatible with the material of the tube, in particular, a polymer tube.

### SUMMARY

In an embodiment, the invention relates to a method for forming a coating in the inner wall of the tube, including the following operations:

moving a segment of a liquid composition of coating particles in suspension inside the tube at a constant controlled speed at least equal to 2 cm/s, so as to drive a homogeneous liquid film over the inner wall of the tube, and
allowing the solvent of the liquid composition to evaporate and the coating particles in suspension to be deposited on the inner wall of the tube.

### DETAILED DESCRIPTION

The following description in combination with the figures is provided to assist in understanding the teachings disclosed herein. The following discussion focuses on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having” or any other variation thereof, are open-ended terms and should be interpreted to mean “including, but not limited to . . . .” These terms encompass the more restrictive terms “consisting essentially of” and “consisting of.” In an embodiment, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present). A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts. Unless indicated otherwise, all measurements are at room temperature, such as about 77° F. (25° C.). For instance, values for viscosity are at 77° F. (25° C.), unless indicated otherwise.

A method for forming a coating in the inner wall of the tube includes the following operations: moving a segment of a liquid composition of coating particles in suspension inside the tube at a constant controlled speed at least equal to 2 cm/s, so as to drive a homogeneous liquid film over the inner wall of the tube, and allowing the solvent of the liquid composition to evaporate and the coating particles in suspension to be deposited on the inner wall of the tube. In an embodiment, the operations may be repeated any number of times, such as at least once, at least twice, or even a greater number of times.

Within the meaning of the invention, “tube” refers to a closed hollow profile whereof the cross-sections of the outer and inner walls do not necessarily describe two concentric circles and may also have any other geometries: square, polygonal, etc.

This method makes it possible to deposit a substantially uniform layer in terms of thickness and homogeneity, which are durable and have good adhesion to the inner wall of the tube. It does not include any thermal treatment and is not in any way likely to damage the material (polymer, etc.) of the tube.

To move the liquid segment in the tube at a constant controlled speed, it is possible to place the tube vertically and to connect the upper end thereof to a reserve of the liquid composition via a valve, or optionally to close one end of the tube near which the latter contains a reasonable quantity of coating liquid, which is next connected to a pressure higher than the atmospheric pressure, via a valve.

A substantially uniform, such as completely regular, film of the liquid coating composition is first deposited on the inner wall of the tube, and then the solvent of this composition evaporates, leaving the deposited coating particles well-adhered to the inner wall of the tube. To the extent that these particles are in a homogeneous concentration in the entire starting liquid composition, the thickness of the coating of particles obtained is also macroscopically constant. Depending on the shape of the particles and the distribution of their dimensions, the obtained coating has a more or less random roughness, which may cause a superhydrophobic surface behavior for hydrophobic particles, and superhydrophilic for hydrophilic particles.

In an embodiment, hydrophobic particles are chosen from metal oxide particles such as silica bearing a hydrophobic coating, hydrophobic polymer particles such as fluoropolymer, polysiloxane, polystyrene, polyester, silicone copolymer, silicone thermoplastic vulcanizate, copolyester, polyamide, polyethylene polypropylene, polyether-ester copolymer, thermoplastic polyurethane, polyether amide block copolymer, polyamide copolymer, styrene block copolymer, polycarbonate, polyolefin elastomer, thermoplastic vulcanizate, ionomer, polyoxymethylene (POM), acrylonitrile butadiene styrene (ABS), acetal, acrylic, polyvinyl chloride (PVC), or a combination thereof.

Metal oxide particles such as silica bearing a hydrophobic coating may be obtained by grafting an R—Si—X3 coupling agent where R is selected from an alkyl, aryl, siloxane, fluoroalkyl group, and X is a halide or an alkoxy group, or else obtained by adsorption of a polysiloxane or of a fluoropolymer at the surface.

“Fluoropolymer” is understood herein to mean a polymer having in its chain at least one monomer chosen from compounds containing a vinyl group capable of opening to polymerize or propagate a polymerization reaction and which contain, directly attached to this vinyl group, at least one fluorine atom, a fluoroalkyl group or a fluoroalkoxy group. Examples of monomers include vinyl fluoride; vinylidene fluoride (VF2); trifluoroethylene (VF3); chlorotrifluoroethylene (CTFE); 1,2-difluoroethylene; tetrafluoroethylene (TFE); hexafluoropropylene (HFP); perfluoro (alkylvinyl) ether, such as perfluoro (methyl vinyl) ether (PMVE), perfluoro (ethylvinyl) ether (PEVE) and perfluoro (propyl vinyl) ether (PPVE); perfluoro (1,3-dioxole); perfluoro (2,2-dimethyl-1,3-dioxole) (PDD); the compound of formula CF₂═CFOCF₂CF(CF₃)OCF₂CF₂X wherein X is SO₂F, CO₂H, CH₂OH, CH₂OCN or CH₂OPO₃H; the compound of formula C CF₂═CFOCF₂CF₂SO₂F; the compound of formula F(CF₂)nCH₂OCF═CF₂ wherein n is 1, 2, 3, 4 or 5; the compound of formula R₁CH₂OCF═CF₂ wherein R₁ is hydrogen or F(CF₂)_{z} and z is 1, 2, 3 or 4; the compound of formula R₃OCF═CH₂ wherein R₃ is F(CF₂)z- and z is 1, 2, 3 or 4; perfluorobutylethylene (PFBE); 3,3,3-trifluoropropene; 2-trifluoromethyl-3,3,3-trifluoro-1-propene. The fluoropolymer may be a homopolymer or a copolymer; it may also include non-fluorinated monomers such as ethylene. In a particular embodiment, the fluoropolymer is chosen from: fluorinated ethylene propylene (FEP), ethylene tetrafluoroethylene (ETFE), polytetrafluoroethylene perfluoropropylvinyl ether (PFA), polytetrafluoroethylene perfluoromethyl vinyl ether (MFA), polytetrafluoroethylene (PTFE), polyvinylidene fluoride (PVDF), ethylene chlorotrifluoroethylene (ECTFE), polychlorotrifluoroethylene (PCTFE), or a combination thereof.

In an embodiment, the term “polysiloxane” is understood herein to mean rubbers having in their polymer chain silicon and oxygen, defined by “Family Q” in standard ASTM D 1418-01a. In an embodiment, the polysiloxane is polydimethylsiloxane (PDMS). In a particular embodiment, the hydrophobic coating includes fumed silica, a polydimethylsiloxane and crosslinker.

In an embodiment, the hydrophobic coating particles have a size of between 5 nm and 10 μm; and in an exemplary embodiment, of between 500 nm and 5 μm.

In an embodiment, the coating particles have a mono- or polydisperse size distribution; the coating which they constitute has a roughness, characterized by the above-mentioned peak-to-valley distance, which can induce a super-hydrophobic behavior as already indicated.

In an embodiment, the inner wall has a contact angle with water of at least 135, such as 150°.

In an embodiment, to allow the solvent of the liquid composition to evaporate and the coating particles in suspension to be deposited on the inner wall of the tube, the tube is left idle at room temperature for at least one hour.

In an embodiment, the static contact angle of a drop of the liquid composition of coating particles in suspension on the inner wall of the tube is at most equal to 20°. The liquid coating composition leaves, by flowing at a constant speed in the tube, a film that is substantially uniform and that does not dry out on the inner wall of the tube. The movement speed of the liquid coating segment can then be adjusted high enough for the fraction of the liquid film that was deposited first not to begin to evaporate before the fraction of the liquid film deposited last is deposited.
According to exemplary embodiments of the method according to the invention, the method may include one or more of the following:
said two preceding operations are repeated until the thickness of the coating is at least equal to 300 nm or until the coating has a micro-texture of between 100 nm and 50 μm;
said two preceding operations are repeated twice, i.e., done three times total; this measure makes it possible in many cases to obtain a desired thickness of the coating;
the movement speed of the liquid segment is at least equal to 5 cm/s, such as 10 cm/s, and at most equal to 50 cm/s; the higher this speed is, the greater the thickness of the liquid film and the quantity of deposited particles are; the latter also depend on properties of the liquid, in a particular embodiment, its viscosity;
prior to the movement of a segment of a liquid composition inside the tube, the latter is first subject to treatment to make the surface hydrophilic such that the contact angle of a drop of water does not exceed 20°;
prior to the movement of a segment of a liquid composition inside the tube, the latter first undergoes a reduction in pressure to a value of no more than 10 mbar, then a plasma activation; this measure seeks to increase the adhesion of the coating of particles to the inner wall of the tube; it results, by creating free radicals, in oxidizing the inner wall of the tube, for example in the case of a tube made from poly(dimethyl siloxane) (PDMS), changing the SiCH₃ sites to SiOH; it for example includes plugging up both ends of the tube, creating a primary vacuum inside the tube such that it is possible for the plasma next to be able to be initiated in the tube and that can be obtained using a pump of the Adixen® type of model PASCAL 2005 SD for 1.5 min., then performing a plasma treatment for 15 s, for example by implementing a high-frequency generator like that produced by the company Electrotechnical Products, Inc., in particular of the type with a Tesla coil, 50/60 Hz, 300 W;
prior to moving a segment of a liquid composition inside the tube, the latter is subject to a chemical activation; like the previous one, this measure also seeks to increase the adhesion of the coating of particles to the inner wall of the tube; it may include treatment using an acid or oxidizing solution;
after moving a segment of a liquid composition inside the tube, the latter is subject to a thermal treatment, such as at room temperature (25° C.) to 150° C. and in an embodiment, for a time of 10 minutes to 24 hours; this measure may increase the adhesion of the coating of particles to the inner wall of the tube.

The invention also relates to a tube able to be obtained using the method described above, characterized in that it is made from a polymer or glass material; it may be a flexible tube made from an elastic material; the tube can be transparent, opaque, colored, made from a thermoplastic polymer material, a thermosetting polymer material, or a combination of the two; in specific embodiments, it is made from a thermoplastic polymer and then in particular includes polystyrene, polyester, silicone elastomer, silicone polymer, thermoplastic silicone vulcanizate, polydimethyl siloxane, polyester, polyamide, fluoropolymer, fluoroelastomer, polyethylene, polypropylene, polyester-ester copolymer, thermoplastic urethane, amide polyether block copolymer, polyamide copolymer, styrene block copolymer, polycarbonate, elastomer polyolefin, natural rubber, nitrile rubber, thermoplastic vulcanizate, ionomer, polyoxyethylene, acrylonitrile butadiene styrene, acetal, acrylic, polyvinyl chloride, or a combination thereof.

According to an exemplary embodiment thereof, the tube may have any of the following features:

the inner wall has a contact angle with the water at least equal to 135, such as 150°;
it has a cylindrical geometry;
the coating particles (of its inner wall) are hydrophobic, for example made from hydrophobic treated silica, or polytetrafluoroethylene (Teflon®);
the coating particles have a dimension of between 5 and 5000 nm;
the coating particles have a mono- or poly-disperse distribution of dimensions; the coating that they make up has a roughness that may cause a super-hydrophobic or -hydrophilic behavior as previously indicated.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Embodiment 1. A method for forming a coating in the inner wall of a tube includes the following operations: moving a segment of a liquid composition of coating particles in suspension inside the tube at a constant controlled speed at least equal to 2 cm/s, so as to drive a homogeneous liquid film over the inner wall of the tube, and allowing the solvent of the liquid composition to evaporate and the coating particles in suspension to be deposited on the inner wall of the tube.

Embodiment 2. The method according to embodiment 1, characterized in that to allow the solvent of the liquid composition to evaporate and the coating particles in suspension to be deposited on the inner wall of the tube, the tube is left idle at room temperature for at least one hour.

Embodiment 3. The method according to any one of the preceding embodiments, characterized in that the static contact angle of a drop of the liquid composition of coating particles in suspension on the inner wall of the tube is at most equal to 20°.

Embodiment 4. The method according to any one of the preceding embodiments, characterized in that said two preceding operations are repeated until the thickness of the coating is at least equal to 300 nm or until the coating has a micro-texture of between 100 nm and 50 μm.

Embodiment 5. The method according to any one of the preceding embodiments, characterized in that said two preceding operations are repeated once.

Embodiment 6. The method according to any one of the preceding embodiments, characterized in that said two preceding operations are repeated twice.

Embodiment 7. The method according to any one of the preceding embodiments, characterized in that the movement speed of the liquid segment is at most equal to 50 cm/s.

Embodiment 8. The method according to embodiment 7, characterized in that the movement speed of the liquid segment is at least equal to 10 cm/s.

Embodiment 9. The method according to embodiment 7, characterized in that the movement speed of the liquid segment is at least equal to 5 cm/s.

Embodiment 10. The method according to any one of the preceding embodiments, characterized in that prior to the movement of a segment of a liquid composition inside the tube, the latter is first subject to treatment to make the surface hydrophilic such that the contact angle of a drop of water does not exceed 20°.

Embodiment 11. The method according to embodiment 10, characterized in that prior to the movement of a segment of a liquid composition inside the tube, the latter first undergoes a reduction in pressure to a value of no more than 10 mbar, then a plasma activation.

Embodiment 12. The method according to embodiment 10, characterized in that prior to moving a segment of a liquid composition inside the tube, the latter is subject to a chemical activation.

Embodiment 13. The method according to any one of the preceding embodiments, characterized in that after the movement of a segment of a liquid composition inside the tube, the latter is subject to thermal treatment of at least 25° C. to 150° C.

Embodiment 14. The method according to embodiment 13, wherein the thermal treatment is for a time of 10 minutes to 24 hours.

Embodiment 15. A tube able to be obtained using the method according to any one of the preceding embodiments, characterized in that it is made from a polymer or glass material.

Embodiment 16. The tube according to embodiment 15, characterized in that the inner wall has a contact angle with the water at least equal to 135, such as 150°.

Embodiment 17. The tube according to embodiment 15, characterized in that it has a cylindrical geometry.

Embodiment 18. The tube according to embodiment 15, characterized in that the coating particles are hydrophobic.

Embodiment 19. The tube according to embodiment 15, characterized in that the coating particles have a dimension of between 5 and 5000 nm.

Embodiment 20. The tube according to embodiment 15, characterized in that the coating particles have a mono- or poly-disperse distribution of dimensions.

The concepts described herein will be further described in the following examples, which do not limit the scope of the disclosure described in the claims. The following examples are provided to better disclose and teach processes and compositions of the present invention. They are for illustrative purposes only, and it must be acknowledged that minor variations and changes can be made without materially affecting the spirit and scope of the invention as recited in the claims that follow.

### EXAMPLES

### Example 1

The inner wall of an extruded polyethylene (PE) tube, 1.5 m long, outer diameter 8.4 mm and inner diameter 6.4 mm, is coated using a solution marketed by the company Soft99 Co. Japan under commercial reference Glaco Mirror Coat “Zero”.

The tube is in a vertical position.

The aforementioned solution contains 85 to 90 wt % of isopropanol, 0.1 to 3 wt % of hydrophobic treated silica particles and 10 to 15 wt % of a mixture of liquefied propane, n-butane and i-butane. The distribution of dimensions of the silica particles is monodisperse; the mean size of the particles is 127.7 nm.

The viscosity of the solution is 2.3 mPa·s (or cP) measured with a “Low shear 400” rheometer marketed by the company Lamy Rheology, working by simple shearing in a Couette geometry at 25° C.

The upper end of the tube is connected to a reservoir of the solution of coating particles in suspension via a valve; the movement speed of the liquid in the tube is constantly 20 cm/s. After passage of a quantity of liquid in the tube, the latter is left at room temperature for 1 hour.

The passage in the tube of the quantity of this liquid, followed by one hour of rest at room temperature, is repeated twice.

A coating is obtained with a regular thickness having a mean value of 1.5 μm, with a roughness of 150 nm measured using a SEM-FEG Jeol 7600F electron-scanning microscope at 2 kV, 20 pA, WD (“Working Distance”, i.e., distance between the measuring head and the sample) 6 mm, in secondary electron mode.

The hydrophobia of the inner wall of the PE tube is evaluated before formation of the coating, then after this formation resulting from the three cycles previously described: to that end, the angles of advance and withdrawal of a drop of water are measured. The angle of advance is the contact angle of a drop measured with a goniometer during the growth of a drop produced using a pipette and a pre-pipette, for example, an angle of withdrawal during the shrinkage of the drop under the same conditions.

On the uncoated polyethylene, the angles of advance and withdrawal are respectively 112° C. and 85° C. (hydrophobic behavior).

On the coated polyethylene, they are both 155° (superhydrophobic behavior).

### Example 2

The inner wall of an extruded silicone tube, having a length of 1.5 m, an outer diameter of 9.6 mm and an inner diameter of 6.4 mm, is coated using a solution containing:

A 9:1 mix of THF and a dispersion containing

A 1:1 proportion of fumed silica (such as the AEROSIL R series, sold by the Evonik company), and a PDMS (such as the Sylgard series from Dow Corning) with a 10/1 ratio of PDMS/crosslinker.

The tube is in a vertical position.

The upper end of the tube is connected to a reservoir of the solution of coating particles in suspension by means of a valve; the speed of movement of the liquid in the tube is constantly 20 cm/s. After passage of an amount of liquid through the tube, the latter is left at 70° C. for 2 hours.

The resulting inner wall of the tube shows a superhydrophobic behaviour.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1. A method for forming a coating in the inner wall of a tube, comprising the following operations:
moving a segment of a liquid composition of coating particles in suspension inside the tube at a constant controlled speed at least equal to 2 cm/s, so as to drive a homogeneous liquid film over the inner wall of the tube, and
allowing the solvent of the liquid composition to evaporate and the coating particles in suspension to be deposited on the inner wall of the tube.

2. The method according to claim 1, characterized in that to allow the solvent of the liquid composition to evaporate and the coating particles in suspension to be deposited on the inner wall of the tube, the tube is left idle at room temperature for at least one hour.

3. The method according to claim 1, characterized in that the static contact angle of a drop of the liquid composition of coating particles in suspension on the inner wall of the tube is at most equal to 20°.

4. The method according to claim 1, characterized in that said two preceding operations are repeated until the thickness of the coating is at least equal to 300 nm or until the coating has a micro-texture comprised between 100 nm and 50 μm.

5. The method according to claim 1, characterized in that said two preceding operations are repeated once.

6. The method according to claim 5, characterized in that said two preceding operations are repeated twice.

7. The method according to claim 1, characterized in that the movement speed of the liquid segment is at most equal to 50 cm/s.

8. The method according to claim 7, characterized in that the movement speed of the liquid segment is at least equal to 10 cm/s.

9. The method according to claim 7, characterized in that the movement speed of the liquid segment is at least equal to 5 cm/s.

10. The method according to claim 1, characterized in that prior to the movement of a segment of a liquid composition inside the tube, the latter is first subject to treatment to make the surface hydrophilic such that the contact angle of a drop of water does not exceed 20°.

11. The method according to claim 10, characterized in that prior to the movement of a segment of a liquid composition inside the tube, the latter first undergoes a reduction in pressure to a value of no more than 10 mbar, then a plasma activation.

12. The method according to claim 10, characterized in that prior to moving a segment of a liquid composition inside the tube, the latter is subject to a chemical activation.

13. The method according to claim 1, characterized in that after the movement of a segment of a liquid composition inside the tube, the latter is subject to thermal treatment of at least 25° C. to 150° C.

14. The method according to claim 13, wherein the thermal treatment is for a time of 10 minutes to 24 hours.

15. A tube able to be obtained using the method according to claim 1, characterized in that it is made from a polymer or glass material.

16. The tube according to claim 15, characterized in that the inner wall has a contact angle with the water at least equal to 135, such as 150°.

17. The tube according to claim 15, characterized in that it has a cylindrical geometry.

18. The tube according to claim 15, characterized in that the coating particles are hydrophobic.

19. The tube according to claim 15, characterized in that the coating particles have a dimension comprised between 5 and 5000 nm.

20. The tube according to claim 15, characterized in that the coating particles have a mono- or poly-disperse distribution of dimensions.
